(19) United States
(12) Patent Application Publication
(10) Pub. No.: US 2020/0370755 A1
(43) Pub. Date: Nov. 26, 2020

(54) METHOD FOR CONTROLLING AT LEAST ONE FUNCTION OF A DOMESTIC APPLIANCE AND CONTROL DEVICE

(71) Applicant: Fujikura Ltd., Tokyo (JP)

(72) Inventors: Gerald Horst, Karlsruhe (DE); Markus Pfeifferer, Lappersdorf (DE); Frank Schaefer, Puchheim (DE); Daniel Vollmar, Pfinztal (DE)

(73) Assignee: Fujikura Ltd., Tokyo (JP)

(21) Appl. No.: 16/636,918

(22) PCT Filed: Jul. 19, 2018
(86) PCT No.: PCT/EP2018/069583

§ 371 Date: Feb. 6, 2020

(30) Foreign Application Priority Data
Aug. 21, 2017 (DE) 10 2017 214 501.3

(51) Int. Cl. F24C 7/08; G03B 17/54; F24C 3/12; G06F 3/01

(52) U.S. Cl. CPC F24C 7/083; G03B 17/54; G05B 2219/23021; G06F 3/017; F24C 3/122

(57) ABSTRACT

In a method for controlling at least one function of a household appliance, a control device senses contactlessly the presence of a user's hand in a sensing space. A characteristic of the sensed hand is detected by the control device, and a function of the household appliance is actuated using the detected characteristic.

The present invention relates to a method for controlling at least one function of a household appliance and a control device.

In order to operate household appliances, devices are known in which a gesture sensing apparatus is used to sense positions and/or movements of an object in a sensing space contactlessly. Operating parameters of the household appliance are set using the sensed gestures. One such operating device is described for instance in DE 10 2014 007 172 A1.

One disadvantage of this operating device consists in the operating parameters being set independently of the current user.

The object of the present invention is therefore to create a solution by means of which this disadvantage is at least reduced and in particular the security and/or user-friendliness of the household appliance can be increased.

The invention is based on the knowledge that this object can be achieved by the hand to be sensed in order to control the function of the household appliance being further analyzed beyond its position and movement.

According to a first aspect, the object is therefore achieved by a method for controlling at least one function of a household appliance, in which the presence of a user's hand in a sensing space is sensed contactlessly by a control device. The method is characterized in that additionally at least one characteristic of the sensed hand is detected by the control device and at least one function of the household appliance is actuated using the at least one detected characteristic.

The household appliance, the function of which is controlled by means of the inventive method, can be a cooker, an extractor hood, an oven, a coffee machine and/or a washing machine, for instance. The function can be one of the main functions of the household appliance, for instance, the activation and/or setting of a heat level of a cooktop, the activation and/or setting of a ventilation mode of an extractor hood, the activation and/or setting of the temperature in an oven, the activation and/or setting of a coffee preparation program of a coffee machine or the activation and/or setting of a wash program of a washing machine, for instance. Moreover, the function can also be additional functions, such as for instance a lighting, a display or other output of contents, for instance. These additional functions can also be executed partially by units in the control device itself. For instance, a projection unit for projecting a control panel for a household appliance can be integrated in the control device.

The control device, which is used inventively for this purpose, can be integrated at least partially in a household appliance. It is also within the scope of the invention that the control device represents a device which is separate from the household appliance or appliances but which is connected to a household appliance at least for signal transmission purposes.

The sensing space in which the user's hand is sensed contactlessly represents the area or space in which a sensing unit of the control device can sense the presence of objects. This can be the coverage area of a camera or another sensor. The sensing unit can be embodied separately from the household appliance, the functions of which are to be controlled. For instance, the sensing unit can be arranged above a cooker and the sensing space is defined by the space between the sensing unit and the cooker. In this embodiment, the sensing unit can be arranged on a further household appliance, in particular an extractor hood, or integrated herein for instance. The sensing space can preferably be illuminated by the sensing unit or another unit so that the user detects when his/her hand is located in the sensing space.

The hand is sensed in the sensing space contactlessly. In particular, the sensing can be sensed by means of a camera or a contactless sensor, for instance a motion sensor. The sensing unit preferably comprises a 3D camera, in particular a 3D camera that operates in the infrared range.

In addition to sensing a user's hand, at least one characteristic of the sensed hand is detected in accordance with the invention by the control device. Recording, measuring or determining in another way the characteristic is referred to as detecting a characteristic. Since the characteristics are preferably further processed in a processing unit, for instance compared with stored data, the characteristics can also be referred to as filter characteristics or filter parameters.

A property of the hand that is recordable, measurable or determinable in another way is therefore in particular referred to as a characteristic of the sensed hand. This refers to a property which is inherent to the hand. The position or movement of the hand in the sensing space therefore does not represent a characteristic of the hand.

Using the at least one detected characteristic, in accordance with the invention the at least one function of the household appliance is actuated. Actuation of the function(s) can be individualized by taking the at least one detected characteristic into account. A series of advantages can be achieved in this way. On the one hand, user friendliness can be increased, in that the functions can be actuated according to user wishes or other specifications. Moreover, security can be increased, since the user can be identified for instance and use can thus be prevented for unauthorized persons.

According to one preferred embodiment, before the actuation the detected characteristic is processed with data which is stored in the control device. The processing preferably represents a comparison with other data or a correlation with other data. The actuation of the at least one function is carried out here as a function of the processing result.

According to one embodiment, the data comprises user-related data and the processing comprises a correlation of the detected characteristic with the user-related data. The correlation enables the user's identity to be determined from the sensed characteristic or characteristics. To this end, the user-related data preferably represents identification data of the user. By identifying the user, it is possible to check whether the user is authorized to actuate and thus execute one or more functions of the household appliance. The user can be authenticated in the process. The use of the household appliance or individual functions of the household appliance by an unauthorized person can therefore be prevented.

The user data is stored in the control device, for instance. Alternatively, the user data is stored in a database or another storage unit, which is connected at least temporarily with the control device.

Alternatively or in addition, the user-related data can comprise a user profile. Functions which are to be executed for the user can be stored in the user profile. In particular, operating parameters of individual functions or contents to be output by a function can be assigned to a user. Multimedia contents to be output by a household appliance can therefore be different for different users. Moreover the display, which represents a user interface of one of the household appliances, for instance, and is output by the control unit or a unit connected thereto, can also be different for each user. A personalization of the functions can therefore take place. Moreover, the control unit can also have a separate user interface. This user interface can also be used to display multimedia contents. Moreover, this user interface can also be personalized using a user profile, for instance.

This is advantageous since different requirements in terms of the appearance of the user interface, which can also be referred to as the control panel or control interface (e.g. buttons, font and icon size adjusted to age, favorites, background images, layout, favorite coffee) and different authorizations can exist for various users. Children are forbidden from operating some appliances, for instance. Online orders should only be carried out by the authorized person. The information relating to the user can therefore be stored in a user profile.

In addition or alternatively to identification data and a user profile, the data can comprise at least one limit value for at least one characteristic and the processing can comprise a comparison with the at least one limit value. A minimum value for a characteristic can be specified in particular as a limit value. A limit value for the size of the hand is preferably specified for the length of the back of the hand in general, or for the length of the fingers. By comparing the size of the hand of parts thereof, which have been identified as characteristics, with a minimum value, it is possible to detect and preferably prevent a child using the household appliance or individual functions of the household appliance. This is advantageous particularly with a household appliance which represents a cooker or an oven. With known household appliance, the child-proofing consists in operating knobs on such household appliances being removable. With such child-proofing, the household appliance can then also not be usable or settable for an adult. By contrast, it is possible using the present invention to detect that the user is an adult and then after authentication of the user, the household appliance can be used.

Actuation of the at least one function of a household appliance can comprise unlocking a locked function, locking an unlocked function, maintaining the locking of a function, activating a function and/or setting operating parameters.

The at least one characteristic of the hand is preferably a biometric characteristic. This type of characteristic is advantageous in particular for the authentication of the user and personalization of the actuation since these characteristics can be assigned uniquely to one person.

Examples of biometric characteristics which can be detected in accordance with the invention are the height of the back of the hand, the width of the back of the hand, the length of the back of the hand, the height of the fingers, the width of the fingers, the length of the fingers, the relative position of the fingers, the handprint and the pattern of the hand veins. The detection of these characteristics is also referred to as hand detection. A number of characteristics cited by way of example can also be used for hand detection. The use of the handprint (palm print) as a characteristic is advantageous in that this is a very stable characteristic and moreover offers more area than a fingerprint. The ability to evaluate is therefore improved. A person's handprint is unique in a similar way to the fingerprint and a unique identification is therefore possible. Although the external appearance of the hand changes with age, as a whole, the bone structure, the relative positions, height and width of the back of the hand and the fingers and the handprint nevertheless remain constant from a specific age. Detecting the filter characteristics can be carried out by sensing the recording of the flat hand, or the characteristics can be determined from this recording.

The handprint and also a combination of several of the other characteristics can be used reliably to identify and authenticate the user. Verification on the basis of the structure of two fingers is also possible.

The hand vein pattern can be sensed by the camera, for instance, which is also used to detect the hand in the sensing space. Here this camera represents a camera which operates in the infrared range. The recording of the back of the hand is sufficient here. Detection is therefore also possible with a clenched hand.

According to one embodiment, the at least one characteristic is detected once after the hand has been sensed.

Particularly preferably after the hand has been sensed, the user is then authenticated by detecting the characteristics of the hand. If, during the comparison with identification data, it is detected that the user is not authorized, one or more functions of the household appliance can be locked; in other words these can no longer be activated and set by the current user. Alternatively, it is also possible, upon detecting that the user is not authorized, for the household appliance or the control device to switch into a mode which requires manual entry of a password.

According to one embodiment, after the hand has been sensed, at least the size of the hand is detected continuously and compared with a limit value. This comparison can also be referred to as filtering. This embodiment is particularly advantageous since in this way after unlocking the functions it is also possible for an authorized user to detect if a child is taking over the operation. To this end, the detected characteristics can be filtered according to the finger length particularly during the entire operation of the household appliance. These parameters are present throughout the entire duration of the operation of the household appliance by means of the control device and there is therefore no additional computing outlay. After sensing the hand, it is also possible to continuously detect further characteristics and to process these. This represents an increased computing outlay, however.

According to a further aspect, the invention relates to a control device for controlling at least one function of a household appliance, wherein the control device has a sensing unit for sensing the presence of a user's hand in a sensing space contactlessly. The control device is characterized in that the control device moreover has a detection unit, by means of which at least one characteristic of the sensed hand is detected, and at least one actuation unit, by means of which at least one function of the household appliance is actuated using the at least one detected characteristic.

Advantages and details which were described in respect of the method according to the invention, also apply, where applicable, to the control device and vice versa.

According to one preferred embodiment, the control device additionally has a processing unit, in which the detected characteristic is processed with data, which is stored in the control device, and wherein the processing unit is connected to the actuation unit so that the actuation is carried out as a function of the processing result. It is also within the scope of the invention that the data is stored in a database or another device, which is connected to the control device, and by way of which the data can be requested. Moreover, it is inventively also possible for the processing unit to represent a unit connected to the control device, said unit being able to communicate wirelessly with the control device, for instance.

According to one embodiment, at least the sensing unit and the detection unit are combined in one module. According to a further embodiment, the control device comprises a gesture detection unit, by means of which gestures are detected for setting operating parameters of the household appliance or further units of the control device, for instance a projection unit.

According to one embodiment, the control device comprises a projection unit for projecting an item of content in the surroundings of the household appliance. The projection unit here represents a unit which can preferably be actuated by the control device, in particular the actuation unit. The projection or the contents of the projection can therefore take place using the detected characteristics of the hand, and a personalization of the projection can take place as a result.

The control device is preferably designed to carry out the inventive method.

The invention is described again below with reference to the accompanying drawings, in which:

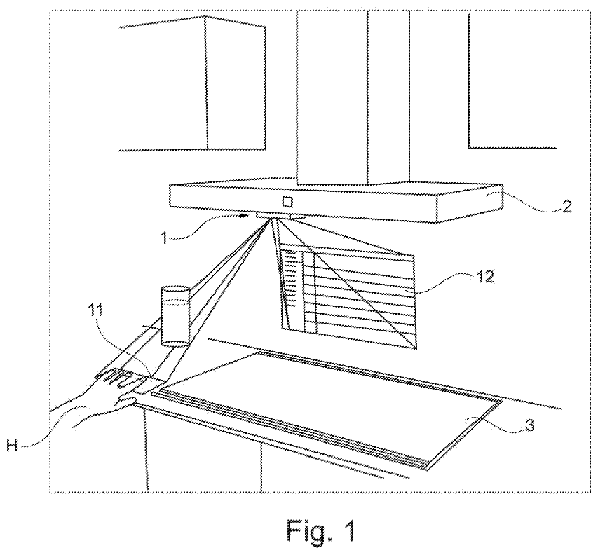

FIG. 1: shows an embodiment of the inventive control device;

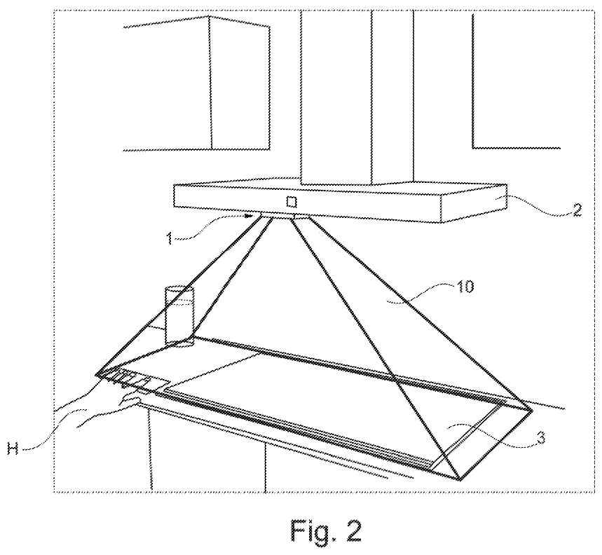

FIG. 2: shows a further embodiment of the inventive control device;

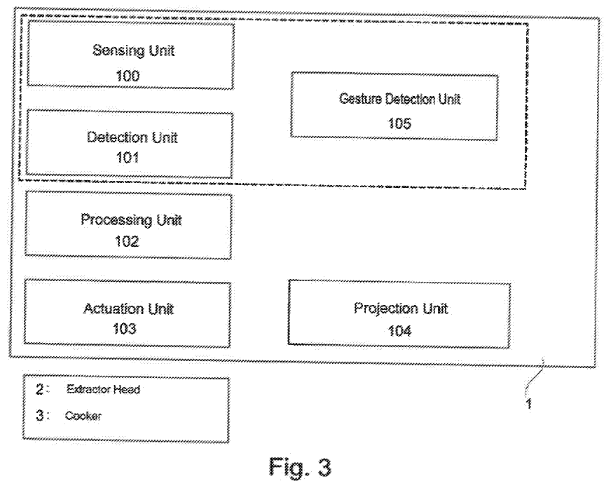

FIG. 3: shows a schematic block diagram of an embodiment of the inventive control device;

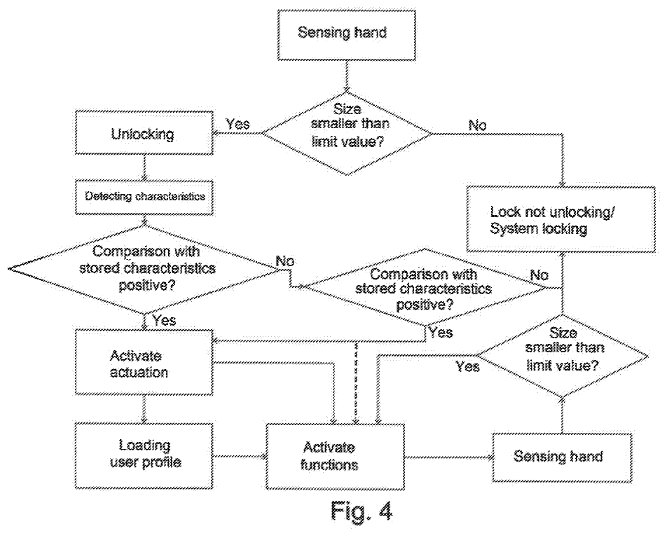

FIG. 4: shows a schematic flow chart of an embodiment of the inventive method; and

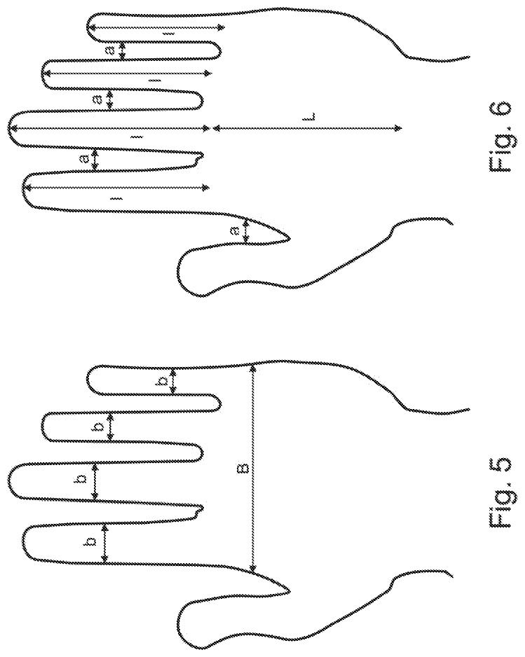

FIG. 5: shows a schematic diagram of the detection of characteristics of a hand; and

FIG. 6: shows a schematic diagram of the detection of characteristics of a hand.

FIG. 1 shows an embodiment of the inventive control device 1. In the embodiment shown, the control device 1 is attached to an extractor hood 2, which is arranged above a cooker 3. In the embodiment shown, the control device 1 comprises a projection unit 104 (see FIG. 2). In the embodiment shown, on the one hand a control panel 11 is shown adjacent to the cooker 3 using the projection unit 104. On the other hand, in the embodiment shown, contents are projected into a projection area 12 on the wall behind the cooker 3. A sensing unit (not visible) is moreover provided in the control unit 1. A sensing area 10 (see FIG. 2) is covered by means of this sensing unit 100 (see FIG. 2), within which a user's hand H can be detected. The control unit preferably comprises a gesture detection unit 105 (see FIG. 2), by means of which the positions and movements (gestures) of the hand H can be detected. On account of the gestures detected in this way, the cooker H and the projection of the contents in the projection area 12 and possibly furthermore the extractor hood 2 is actuated, after the control device 1 has unlocked the corresponding functions and these were possibly set according to a stored user profile.

As can be seen in FIG. 3, the control device 1 comprises a sensing unit 100 and a detection unit 101. Moreover, preferably provided in the control device 1 or connected hereto is a processing unit 102 with an actuation unit 103 for actuating the functions of a household appliance 2, 3. Moreover, a gesture detection unit 105 is shown in FIG. 3 as further units of the control device 1, which gesture detection unit can use results from the sensing unit 100 and detection unit 101, for instance sensed images. Furthermore, a projection unit 104 is shown, by means of which for instance a control panel 11 for a household appliance or an item of content 12, for instance multimedia content, can be projected onto a wall. The projection unit 104 can be connected to the actuation unit so that the contents output by the projection unit 104 are defined by the previous processing of the detected characteristics.

The use of the inventive control device 1 is explained again below with reference to FIG. 4. FIG. 4 shows a flow chart of an embodiment of the inventive method.

With a deactivated control device 1, in other words when the control device 1 is switched off, the presence of a user can be detected by a proximity sensor (not shown) and the control device 1 can be brought into a standby condition, in which this is still locked, for instance. If a user's hand H, which enters the sensing area 10 of the detection unit 100 of the control device 1, is sensed in this condition, this is sensed by the sensing unit 100. In accordance with the invention, the size of the hand can first be determined after sensing the hand H and compared with a limit value which can be stored in the control device 1. If the size of the hand is smaller than the limit value, the locking of the control device 1 is not removed. This can prevent a child from being able to operate the household appliance, in particular the cooker 3 or the extractor hood 2.

If, by contrast, it is established in the comparison that the size of the hand is larger than a stored limit value, the control device 1 is unlocked. In this state a detection unit 101 of the control device 1 is used to detect characteristics of the hand H. For instance, the width of the back of the hand, the length of the back of the hand, the relative position of the fingers with respect to one another can be detected. The detection unit 101 can therefore comprise a 3D camera, for instance. In addition or alternatively, the detection unit 101 can also detect the vein pattern on the back of the hand as a characteristic of the hand H. The characteristic or characteristics detected in this way is/are then processed with stored user-related data. In particular, the detected characteristics are compared with stored characteristics and if the characteristics match, an authentication of the user may additionally be carried out. If the detected characteristics match the stored characteristics and if, provided an authentication of the user is carried out, the user has been authenticated, actuation of functions of the household appliance, in particular of the cooker 3, the extractor hood 2 and possibly the projection unit 104, is activated. If the detected characteristics do not match the stored characteristics, the control device 1 is locked again. Alternatively, an authentication request can be output to the user before the control device is locked. This may take place by means of the projection unit 104, for example. If a required password is input in response to the authentication request, for instance, the actuation can be activated.

In particular, a user profile is loaded after authentication of the user in the processing unit. Settings for the household appliance/appliances 2, 3 and/or contents can be stored in the processing unit for display in the projection area 12 or for the projection of the control panel 11. On account of these settings or on account of gestures detected by the gesture detection unit 105, the functions of the household appliance 2, 3 and/or the projection unit 104 are then further actuated.

After actuating the functions of the household appliance 2, 3, the hand is preferably also then sensed if a further hand is sensed or at predetermined time intervals. The hand is preferably detected with respect to its size and the size is compared with a limit value. If the size is smaller than the limit value, the control unit 1 is blocked and the further actuation of functions of the household appliance 2, 3 is therefore prevented. By contrast, if the size is larger than the limit value, actuation of the functions is continued.

FIGS. 5 and 6 show schematic representations of different ways of detecting characteristics of the hand. From the image of a hand H detected by means of a 3D camera, for instance, the width of the back of the hand B and/or the width b of one or all fingers can be determined, as shown in FIG. 5. FIG. 6 shows that the length of the back of the hand L, the length of the fingers I and/or the distance a between the fingers can be determined from a sensed image of the hand H.

The present invention is not restricted to the embodiments shown. In particular, a number of units of the control device can be combined, for instance.

A series of advantages can be achieved with the present invention. On the one hand, by detecting characteristics of the hand, the interacting user can be uniquely identified. This can be used to authorize the user or to personalize the settings. With the present invention, an explicit step to identify/authorize the user is moreover not required. This step, which is required in known systems, can be intentionally deactivated in systems of the prior art, but at the cost of security and a personalized profile. The inputting of a code or password or unlock pattern is also not necessarily required with the present invention. If need be, in the case of a difference between stored characteristics and detected characteristics of the hand this can be requested in order to enable a visitor to use the household appliance.

Moreover, known removable operating elements are not required for child-proofing purposes. As a result, it is possible to eliminate the drawback whereby in most instances a barrier is produced for authorized groups of people and their workflow and cooking experience are interrupted.

In particular, with the embodiment in which the functions of the household appliances and projected contents are controlled by gestures, the inventive identification with the aid of the control device does not interrupt the workflow and is also not perceived by the user to be an interruption.

Furthermore, compared with other methods in which for instance a fingerprint sensor is used, for instance, with the inventive method the characteristics are detected contactlessly. This is advantageous in the field of cooking and baking in particular since the hands do not have to be cleaned and dried for use.

Compared with conventional systems, using the present invention an operating interface can therefore be realized, which allows for a personalized operation while simultaneously maintaining security against unauthorized operation, without interrupting the workflow and without negatively affecting the cooking experience.

### LIST OF REFERENCE SIGNS

1 control device
10 sensing area
11 projection—control panel
12 projection area—contents
100 sensing unit
101 detection unit
102 processing unit
103 actuation unit
104 projection unit
105 gesture detection unit
2 household appliance (extractor hood)
3 household appliance (cooker)
H hand
L length of the back of the hand
I length of the fingers
a distance between fingers
B width of the back of the hand
b width of the fingers

1-17. (canceled)

18. A method for controlling at least one function of a household appliance, said method comprising;
sensing contactlessly by a control device a presence of a user's hand in a sensing space;
detecting a characteristic of the sensed hand by the control device; and
actuating a function of the household appliance using the detected characteristic.

19. The method of claim 18, further comprising, prior to actuating the function of the household appliance, processing the detected characteristic with data which is stored in the control device, wherein the function of the household appliance is actuated as a function of a result of the processing of the detected characteristic.

20. The method of claim 19, wherein the data comprises user-related data and the processing of the detected characteristic comprises a correlation of the detected characteristic with the user-related data.

21. The method of claim 20, wherein the user-related data is identification data of the user.

22. The method of claim 20, wherein the user-related data comprises a user profile.

23. The method of claim 19, wherein the data comprises at least one limit value for the characteristic and the processing of the detected characteristic comprises a comparison with the at least one limit value.

24. The method of claim 18, wherein the actuating of the function of the household appliance comprises unlocking a locked function, locking an unlocked function, maintaining the locking of a function, activating a function, setting operating parameters, and any combination thereof.

25. The method of claim 18, wherein the characteristic of the hand is a biometric characteristic.

26. The method of claim 25, wherein the biometric characteristic is a height of a back of the hand, a width of the back of the hand, a length of the back of the hand, a height of fingers of the hand, a width of the fingers, a length of the fingers, a relative position of the fingers, a handprint or a pattern of hand veins.

27. The method of claim 18, wherein the characteristic is detected once after the hand has been sensed.

28. The method of claim 18, wherein, after the hand has been sensed, a size of the hand is detected continuously and compared with a limit value.

29. A control device for controlling at least one function of a household appliance, said control device comprising:
a sensing unit configured to sense a presence of a user's hand in a sensing space contactlessly;
a detection unit configured to detect a characteristic of the sensed hand; and
an actuation unit configured to activate a function of the household appliance using the detected characteristic.

30. The control device of claim 29, further comprising a processing unit configured to process the detected characteristic with data stored in the control device to thereby establish a processing result, said processing unit being connected to the actuation unit so that the function of the household appliance is actuated as a function of the processing result.

31. The control device of claim 29, wherein the sensing unit and the detection unit are combined in a module.

32. The control device of claim 29, further comprising a gesture detection unit configured to set an operating parameter of the household appliance or to detect a further unit of the control device.

33. The control device of claim 29, further comprising a projection unit configured to project an item of content in a surroundings of the household appliance.

34. The control device of claim 30, wherein the data comprises user-related data, said processing unit being configured to correlate the detected characteristic with the user-related data.

35. The control device of claim 34, wherein the user-related data is identification data of the user.

36. The control device of claim 34, wherein the user-related data comprises a user profile.

37. The control device of claim 30, wherein the data comprises at least one limit value for the characteristic, said processing unit configured to compare the detected characteristic with the at least one limit value.

38. The control device of claim 29, wherein the actuating of the function of the household appliance comprises unlocking a locked function, locking an unlocked function, maintaining the locking of a function, activating a function, setting operating parameters, and any combination thereof.

39. The control device of claim 29, wherein the characteristic of the hand is a biometric characteristic.

40. The control device of claim 39, wherein the biometric characteristic is a height of a back of the hand, a width of the back of the hand, a length of the back of the hand, a height of fingers of the hand, a width of the fingers, a length of the fingers, a relative position of the fingers, a handprint or a pattern of hand veins.

41. The control device of claim 29, wherein the detection unit is configured to detect the characteristic once after the hand has been sensed by the sensing unit.

42. The control device of claim 29, wherein, after the hand has been sensed by the sensing unit, a size of the hand is detected continuously and compared with a limit value.
